(19) United States
(12) Patent Application Publication
(10) Pub. No.: US 2011/0203863 A1
(43) Pub. Date: Aug. 25, 2011

(54) MULTI-POWER OUTPUT DEVICE FOR VEHICLE DRIVING SYSTEMS

(76) Inventor: Chih-Sheng YEH, Nantou County (TW)

(21) Appl. No.: 12/709,931

(22) Filed: Feb. 22, 2010

(51) Int. Cl. B60K 6/00

(52) U.S. Cl. 180/69.6

(57) ABSTRACT

The present invention discloses a multi-power output device for vehicle driving systems, which propels a vehicle having at least one wheel and comprises a primary power output device, a primary speed-change device, at least one auxiliary power output device, at least one auxiliary stepless speed-change device and at least two transmission devices. The primary power output device and the at least one auxiliary power output device respectively output driving power. The primary speed-change device, auxiliary stepless speed-change device and the transmission devices are coupled to drive the wheels to rotate and propel the vehicle to move. The present invention uses the primary power output device and the auxiliary power output devices to output driving power and uses the auxiliary stepless speed-change devices and the primary speed-change device to change the rotation speed of the driving power to output severalfold horse power to upgrade the acceleration capability of the vehicle.

### FIELD OF THE INVENTION

The present invention relates to a vehicle power output system, particularly to a vehicle driving system equipped with a multi-power output device.

### BACKGROUND OF THE INVENTION

Vehicles are important transportation. A power output system is used to propel a vehicle having at least one wheel (usually four wheels) and includes a power output device, a speed-change device and a transmission device. The power output device may be an internal-combustion engine or an electric motor. The speed-change device performs the speed change of the driving power output by the power output device. The transmission device links to the wheels and transmits the driving power to drive the wheels and propel the vehicle.

The acceleration capability of a vehicle depends on HP (Horse Power) output by the power output device of the conventional power output system. To improve the acceleration capability, the user has to replace the original power output device with a higher HP one or refit the original power output device. Once a higher HP power output device is used, the original speed-change device and transmission device are also replaced to match the higher HP power output device lest the higher horse power damages the original speed-change device and transmission device. The higher HP power output devices are expensive because they are rare and hard to cost down by mass-production. Comparing the investment with the increased horse power, it is found to be cost-inefficient to replace the original power output device with a higher HP power output device. Moreover, refitting the original power output device can only increase limited horse power and thus is cost-inefficient also. Therefore, the conventional technology is hard to satisfy the requirement of users.

### SUMMARY OF THE INVENTION

The primary objective of the present invention is to provide a driving system equipped with a multi-power output device, which uses a plurality of low-cost power output devices to generate and output severalfold horse power to meet user's requirement.

To achieve the abovementioned objective, the present invention proposes a multi-power output device for vehicle driving systems, which is used to propel a vehicle having at least one wheel, and which comprises a primary power output device, a primary speed-change device, at least one auxiliary power output device, at least one auxiliary stepless speed-change device and at least two transmission devices, wherein the number of the auxiliary stepless speed-change device corresponds to that of the auxiliary power output device, and wherein the primary power output device and the at least one auxiliary power output device respectively output driving power, and wherein the primary speed-change device and the at least one auxiliary stepless speed-change device are respectively coupled to the primary power output device and the at least one auxiliary power output device to change the output rotation speed of power, and wherein the at least two transmission devices are respectively coupled to the primary speed-change device and the at least one auxiliary stepless speed-change device, and wherein the at least two transmission devices are also coupled to the wheels to propel the vehicle.

In the present invention, the low-cost auxiliary power output devices output driving power, the auxiliary stepless speed-change devices automatically coordinate with the primary speed-change device, and the transmission devices transmit the driving power to the wheels to output severalfold horse power to promote the acceleration capability with a lower cost, and thus meets the user's requirement.

### BRIEF DESCRIPTION OF THE DRAWINGS

FIG. 1 is a diagram schematically showing a multi-power output device applied to a vehicle according to one embodiment of the present invention.

### DETAILED DESCRIPTION OF THE PREFERRED EMBODIMENTS

Below, the embodiments are described in detail to demonstrate the technical contents of the present invention. However, it should be understood that the embodiments are only to exemplify the present invention but not to limit the scope of the present invention.

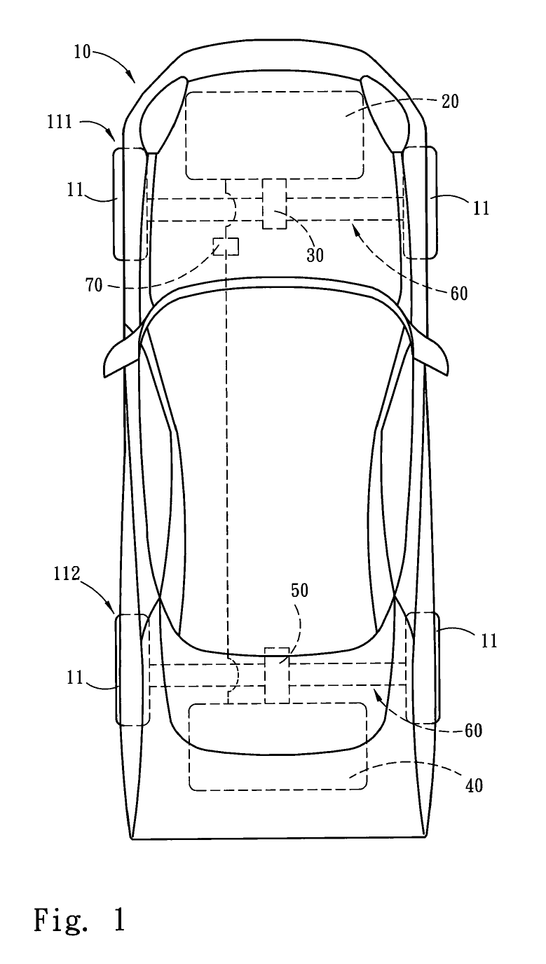

Refer to FIG. 1 for one embodiment of the present invention. The present invention proposes a multi-power output device for vehicle driving systems, which propels a vehicle 10 having at least one wheel 11, and which comprises a primary power output device 20, a primary speed-change device 30, at least one auxiliary power output device 40, at least one auxiliary stepless speed-change device 50 and at least two transmission devices 60. The number of the auxiliary stepless speed-change device 50 corresponds to that of the auxiliary power output device 40. The primary power output device 20 and the at least one auxiliary power output device 40 respectively output driving power. The primary speed-change device 30 and the at least one auxiliary stepless speed-change device 50 are respectively coupled to the corresponding primary power output device 20 and the corresponding auxiliary power output device 40 to change the output rotation speed of the driving power. The at least two transmission devices 60 are respectively coupled to the primary speed-change device 30 and the at least one auxiliary stepless speed-change device 50, and the at least two transmission devices 60 are also coupled to the wheels 11 to propel the vehicle 10 to move.

The auxiliary stepless speed-change device 50 can automatically vary the ratio of the output rotation speed and the input rotation speed, i.e. the auxiliary stepless speed-change device 50 can perform automatic stepless speed change. When the primary power output device 20 and a plurality of auxiliary power output devices 40 output driving power to the wheels 11 simultaneously, the auxiliary stepless speed-change devices 50, which are respectively coupled to the corresponding auxiliary power output devices 40, can automatically coordinate to integrate the driving power to the wheels 11, namely to form severalfold output horse power.

In this embodiment, the vehicle 10 has four wheels 11. However, the present invention does not limit the number of the wheels of a vehicle. When the present invention applies to a rail vehicle, the vehicle may have only a single wheel. When the vehicle is in form of a motorcycle, the vehicle has two wheels. When the vehicle is in form of a truck, the vehicle may have eight wheels.

In this embodiment, the four wheels 11 are respectively arranged on two sides of the vehicle 10. The two front wheels 11 are coupled to form a front wheel set 111, and the two rear wheels 11 are coupled to form a rear wheel set 112. In this embodiment, there is a single auxiliary power output device 40. The primary power output device 20 and the auxiliary power output device 40 are respectively arranged in the front side and the rear side of the vehicle 10 to balance the weight distribution of the vehicle 10. Via the speed change of the primary speed-change device 30 and the auxiliary stepless speed-change device 50 and via the at least two transmission devices 60, the primary power output device 20 and the auxiliary power output device 40 respectively drive the front wheel set 111 and the rear wheel set 112 to rotate and propel the vehicle 10 to move. In other words, the front wheel set 111 and the rear wheel set 112 are respectively driven to rotate by the primary power output device 20 and the auxiliary power output device 40 to accelerate the vehicle 10 with double output horse power.

In this embodiment, the present invention further comprises a control device 70. The control device 70 is coupled and controls the primary power output device 20 and the at least one auxiliary power output device 40 to operate synchronously. The primary power output device 20 and the auxiliary power output device 40 may be in form of an electric motor or an internal-combustion engine. The primary speed-change device 30 may be a traditional four-step, five-step or six-step speed change device, or a stepless speed-change device. No matter what type the primary speed-change device 30 is, it can integrate the horse power to form severalfold horse power via the technology of the present invention.

In the multi-power output device of the present invention, the primary power output device 20 and the at least one auxiliary power output device 40 output driving power; the primary speed-change device 30 and the auxiliary stepless speed-change device 50 automatically coordinate the driving power and transmit the driving power to the wheels 11 via the at least two transmission devices 60 to accelerate the vehicle 10 with severalfold horse power. Thereby, the vehicle 10 has a higher acceleration capacity. Further, the primary power output device 20, primary speed-change device 30, at least one auxiliary power output device 40, at least one auxiliary stepless speed-change device 50 and at least two transmissions device 60 can adopt the mass-produced standard components to reduce the cost. Therefore, the user can upgrade the horse power of his/her vehicle with limited investment.

What is claimed is:

1. A multi-power output device for vehicle driving systems, used to propel a vehicle having at least one wheel, comprising:
a primary power output device outputting a first driving power;
a primary speed-change device coupled to the primary power output device and changing a rotation speed of the first driving power;
at least one auxiliary power output device respectively outputting a second driving power;
at least one auxiliary stepless speed-change device respectively coupled to the corresponding auxiliary power output device to change rotation speed of the second driving power in a stepless manner, wherein a number of the at least one auxiliary stepless speed-change device corresponds to that of the at least one auxiliary power output device; and
at least two transmission devices respectively coupled to the corresponding primary speed-change device and the corresponding at least one auxiliary stepless speed-change device and coupled to the wheels to propel the vehicle to move.

2. The multi-power output device according to claim 1, wherein the vehicle has four wheels respectively arranged at two sides of the vehicle, and wherein two front wheels are coupled to form a front wheel set, and two rear wheels are coupled to form a rear wheel set, and wherein the vehicle has a single auxiliary power output device, and wherein the primary power output device and the auxiliary power output device are respectively arranged in a front side and a rear side of the vehicle and respectively coupled to the primary speed-change device, the auxiliary stepless speed-change device and the two transmission devices to respectively drive the front wheel set and the rear wheel set to rotate and propel the vehicle to move.

3. The multi-power output device according to claim 1 further comprising a control device being coupled and controlling the primary power output device and the at least one auxiliary power output device.

4. The multi-power output device according to claim 1, wherein the primary power output device is a motor.

5. The multi-power output device according to claim 1, wherein the at least one auxiliary power output device is a motor.

6. The multi-power output device according to claim 1, wherein the at least one auxiliary power output device is an engine.

7. The multi-power output device according to claim 1, wherein the primary power output device is an engine.

8. The multi-power output device according to claim 1, wherein the primary speed-change device is a stepless speed-change device, a four-step speed-change device, a five-step speed-change device, or a six-step speed-change device.
